(19) United States
(12) Patent Application Publication
(10) Pub. No.: US 2010/0229766 A1
(43) Pub. Date: Sep. 16, 2010

(54) SUPPORTING TABLE WITH A SUPPORTING SURFACE WHICH IS VARIABLE IN SIZE

(76) Inventor: Reinhard Diem, Herrenberg (DE)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 11/917,919

(22) PCT Filed: Jun. 19, 2006
(86) PCT No.: PCT/DE06/01048

§ 371 Date: Jun. 1, 2010

(30) Foreign Application Priority Data
Jun. 20, 2005 (DE) 20 2005 009 727.6

(51) Int. Cl. A47B 1/00; B26D 7/20; A47B 1/06

(52) U.S. Cl. 108/68

(57) ABSTRACT

A supporting table with a supporting surface which is variable in size for plate-like materials, with a link conveyor which forms the supporting surface and is composed of individual bearing elements which are mounted at their end sides on a table frame and are guided via deflecting rollers movable along the table frame. The link conveyor has transport chains on both sides with pins protruding on both sides, the pins of an outer chain link being assigned to a bearing element, the pins facing the bearing element being fixed on the bearing element and those pins of a bearing element which face the table frame having a slide, which is movable in the axial direction of the pins, for optional engagement with the table frame.

### TECHNICAL FIELD OF THE INVENTION

The present invention concerns a supporting table with a supporting surface which is variable in size for plate-like materials, with a link conveyor which forms the supporting surface and is composed of individual bearing elements which are mounted at their end sides on a table frame and are guided via deflecting rollers movable along the table frame.

### DESCRIPTION OF THE RELATED ART

Such a supporting table and its use are described in principle in WO 03 01 6004. Because this supporting table is intended to accept heavy materials, it is necessary that, on the one hand, the mounting of the link conveyor be sufficiently strong and that, on the other hand, the mounting can be released as easily as possible in order to move the link conveyor away and downward around the deflecting rolls, or vice versa.

The supporting table described above is known from U.S. Pat. No. 3,262,348 where slides arranged in bores in the bearing elements engage a corresponding groove in the table frame. In the bore, the slides have additional axial spring elements. Transport is accomplished by means of belts located at the inner end of the bore located in the bearing element. The supporting table described there serves as a support device for fabrics, and not for heavy plate-like materials such that this design is relatively costly and also leads to a weakening of the carrying capacity of the supporting surface.

### SUMMARY OF THE INVENTION

Therefore, the present invention addresses the problem by proposing a supporting table that is suitable for supporting plate-like heavy materials and can be produced cost-efficiently with a minimum of components while offering high operational reliability.

According to the invention, this problem is solved by a supporting table with the characteristics of the main claim. Additional advantageous embodiments are specified in the dependent claims.

According to the invention, the supporting table has a link conveyor with transport chains on both sides that have pins protruding on both sides. Such transport chains are commercially available, and the pins on both sides pass through the axes of the chain links. The pins of an outer chain link are each assigned to a bearing element. This has the effect that the stronger chain links are attached to the bearing elements and that the elongation of the chains that will occur over time, especially due to the inner chain links, does not affect the bearing elements. The pins facing the bearing element are fixed on the bearing element, and the pins of a bearing element that face the table frame have a slide, movable in the axial direction of the pins, for optional engagement of the table frame.

This arrangement does not weaken the material of the individual bearing elements because the bolts can be fastened firmly to the respective bearing element. In addition, a high carrying capacity is achieved because of the pins. The slide that is movable in the axial direction on the pins assigned to the table frame is easy to install and also ensures a high carrying capacity.

Advantageously, for a simple installation of the slide, said slide can be slipped onto the pins on the front side, and can be fastened to them. Expediently, the slide can be moved on the pins in the axial direction, with the slide movement limited by stops, and this can be achieved by various means known to a person skilled in the art. One simple possibility for accomplishing this is the insertion of a spring ring with a corresponding groove around a pin.

According to an additional embodiment of the invention, the slide is guided positively. The positive guidance can be accomplished by dual or single cam guides that are mounted in a suitable manner on the supporting table. According to a preferred embodiment, on the underside the slide has a guide element for engaging a cam guide, preferably a guide wheel that rotates around the vertical axis. Advantageously, the guide wheel may be implemented as a hard rubber wheel in order to avoid noise. Advantageously, it runs between two guide rails of the cam guide, so that a positive guidance of the slide in both directions is ensured. If only one guide rail is used, an appropriate return force by means of spring elements is required, which usually complicates the assembly of the supporting table.

In order to ensure that the movement of the cam guide is synchronized with the deflecting rollers, because this is necessary for the functioning of a supporting table with a supporting surface of variable size, the cam guides are connected to the shafts of the deflecting rollers and are moved together with these shafts.

In order to be able to hold the bearing elements on the table frame or to move the bearing elements away in a downward direction without problems, the slide rests on the table frame. In order to prevent problems from occurring at the edge at which the bearing elements move out of or into the plane of the table, additional chamfered edges on the slides or appropriate guide ramps may be provided. A ramp of this type minimizes the friction on the table frame in the region of the deflection.

According to an additional embodiment, the pins facing the bearing element are fixed in a connecting element that is fastened from below to the appropriate bearing elements below the supporting surface. The bearing elements may be made from a T-section or any other suitable sectional material with sufficient carrying capacity.

The supporting table according to invention has the distinction that it can be produced and assembled in a simple manner, that damaged elements like bearing elements or slides are easy to replace, and that the bearing elements are attached without play to the link chain. This attachment without play is also important because the bearing elements that would then be easily movable would otherwise impact the material placed on the table when moving up to the support surface plane. By arranging the support surface on one side of the link chain and the support surface on the table frame on the other side of the link chain, and the attachment to the pins, they are disconnected from each other.

### BRIEF DESCRIPTION OF THE DRAWINGS

The invention is explained in detail below by means of an embodiment and with reference to the accompanying drawings.

FIG. 1 shows the schematic view of the known arrangement of a supporting table of this type with a supporting surface which is variable in size;

FIG. 2 shows a detail section through a supporting table with a bearing element with retracted slide;

FIG. 3 shows a view according to FIG. 2 with extended slide;

FIG. 4 shows a top view of the supporting table according to FIG. 2 in a schematic view with retracted slide;

FIG. 5 shows the top view corresponding to FIG. 4 for the extended slide according to FIG. 3;

FIG. 6 shows an enlarged top view of a slide, and

FIG. 7 shows a sectional view through a bearing element along the line A-A, in accordance with FIG. 4.

### DETAILED DESCRIPTION OF THE INVENTION

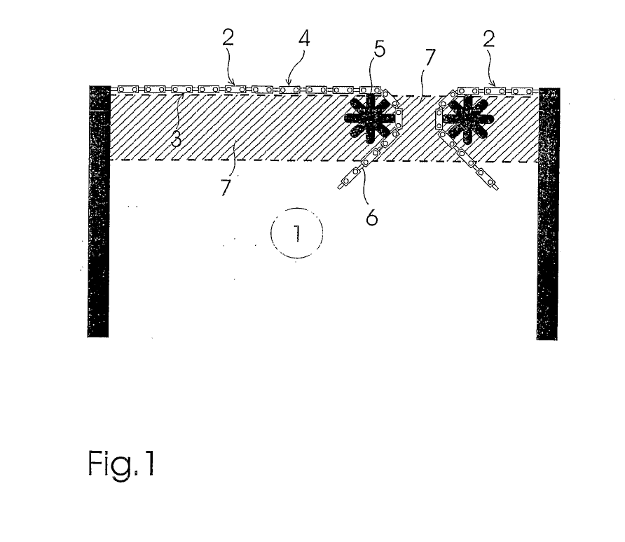

FIG. 1 shows the principle of the use of a supporting table 1 with supporting surfaces 2 that are variable in size. The supporting surface is formed by a link conveyor 3 that consists of individual bearing elements that are fastened on the front side to transport chains that are guided over deflecting rollers 5 that are movable along the table frame 7. This makes it possible to vary the gap that is formed between the deflecting rollers 5, for example for a cutting device for cutting the plate-like material resting on the table.

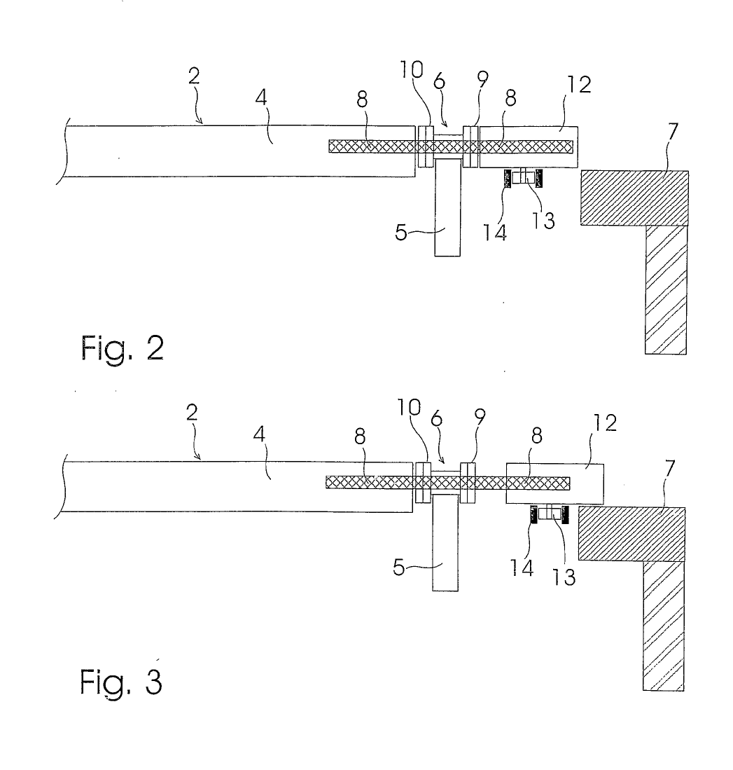

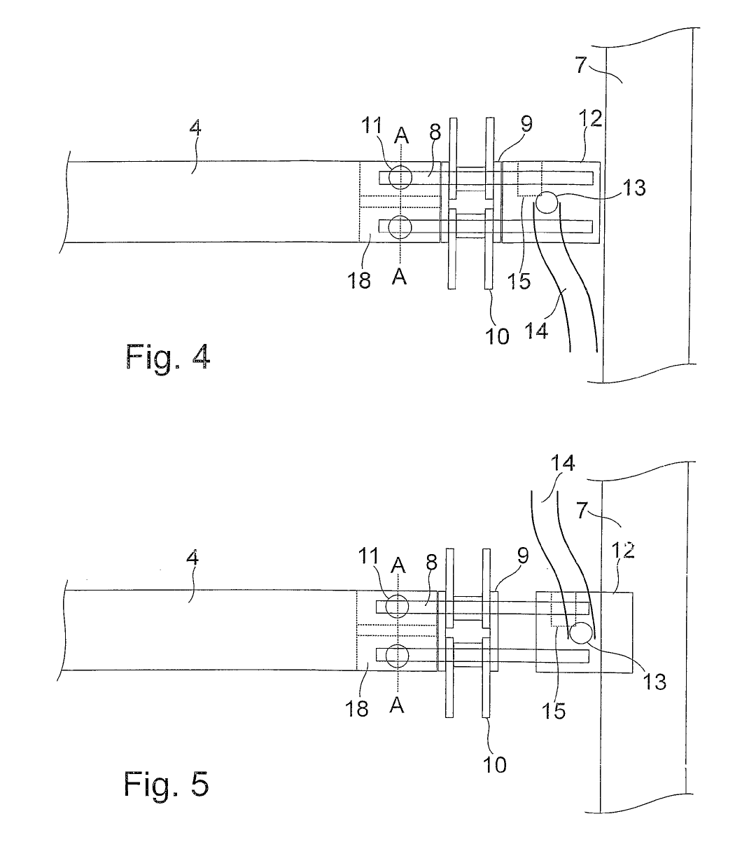

FIG. 2 and FIG. 4 show a bearing element 4 in “12 o'clock” position in relation to the deflecting roller 5. The bearing element 4 is held via two pins 8 that pass through the axis of rotation of an outer chain link 9 and of an inner chain link 10. By means of set screws (not shown), the pins 8 are fixed in a connecting element 18 that is connected to the bearing element 4 by means of the screw connections 11. On the other side of the chain links 9, 10, there is a slide 12 that is movable in the axial direction of the pins 8 and has on the underside a guide wheel 13 that rotates around the vertical axis and is preferably made of hard rubber. The guide wheel runs in a cam guide 14 that has the effect of positively guiding the slide 12. In the figures, the cam guide 14 is shown only in that region in which it has the effect of positively guiding the slide 12. It extends downward next to the deflecting roller 5 to below the table surface plane. There, the guide wheel 13 is released, or is captured by means of an appropriate funnel-shaped cam guide (not shown). The cam guide 14 is moved together with the deflecting roller 5 along the table frame 7.

FIGS. 3 and 5 show the bearing element 4 with the slide 12 in a position in which the slide 12 rests on the table frame 7. This is effected by the cam guide 14 in which the guide wheel 13 on the underside of the slide 12 moves.

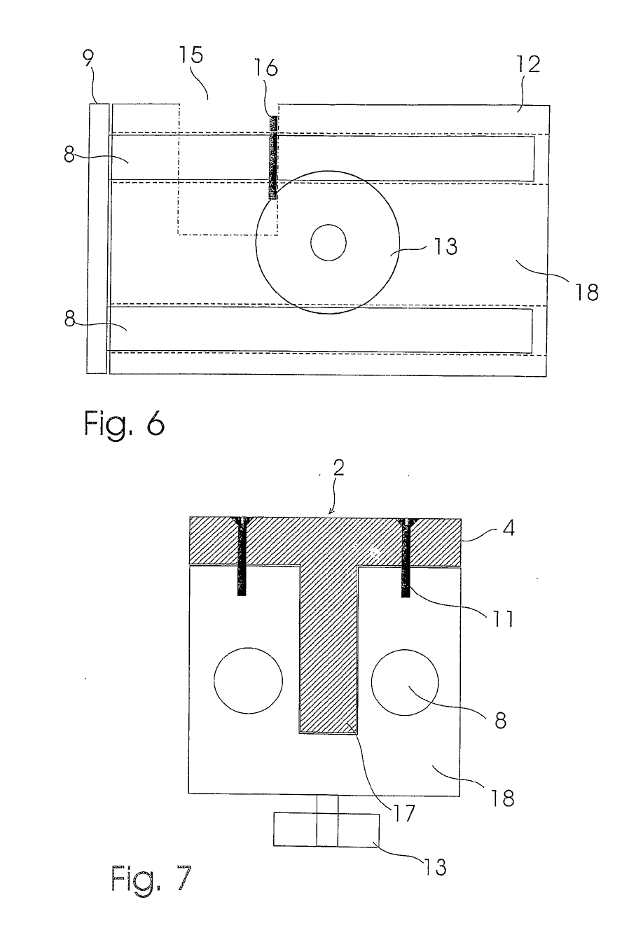

The slide 12 has longitudinal bores for accepting the pins 8 and, as shown enlarged in FIG. 6, a recess 15. For the purpose of assembly, the slide 12 is slipped over the pins 8 and held in place by means of a spring ring 16 that engages a corresponding groove. Therefore, the slide 12 is limited by stops in accordance with the width of the recess 15.

In the embodiment, the bearing elements according to FIG. 7 are designed as T-sections, and the pins 8 are held in place on both sides of the center limb 17 in a connecting element 18 by means of screw elements 11.

1. A supporting table with a supporting surface which is variable in size for plate-like materials, with a link conveyor which forms the supporting surface and is composed of individual bearing elements which are mounted at their end sides on a table frame and are guided via deflecting rollers movable along the table frame, wherein the link conveyor has transport chains on both sides with pins protruding on both sides, the pins of an outer chain link being assigned to a bearing element, the pins facing the bearing element being fixed on the bearing element, and those pins of a bearing element which face the table frame having a slide, which is movable in the axial direction of the pins, for optional engagement with the table frame.

2. A supporting table as claimed in claim 1, wherein the slide can be slipped onto and fixed on the pins on the front side.

3. A supporting table as claimed in claim 2, wherein the slide can be moved on the pins in the axial direction, limited by stops.

4. A supporting table as claimed in claim 1, wherein the slide is guided positively.

5. A supporting table as claimed in claim 4, wherein on the underside, the slide has a guide element, preferably a guide wheel rotating around the vertical axis that engages a cam guide.

6. A supporting table as claimed in claim 5, wherein the cam guide can be moved along the table frame together with the deflecting rollers, and is preferably attached to the shafts of the deflecting rollers.

7. A supporting table as claimed in wherein, the slide rests on the table frame.

8. A supporting table as claimed in claim 1, wherein the pins facing the bearing element are held in a connecting element that is fastened from below to the appropriate bearing element.
